(19) United States
(12) Patent Application Publication
(10) Pub. No.: US 2010/0259688 A1
(43) Pub. Date: Oct. 14, 2010

(54) METHOD OF DETERMINING A STARTING POINT OF A SEMANTIC UNIT IN AN AUDIOVISUAL SIGNAL

(75) Inventors: Bastiaan Zoetekouw, Eindhoven (NL); Pedro Fonseca, Eindhoven (NL); Lu Wang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/741,840

(22) PCT Filed: Nov. 10, 2008
(86) PCT No.: PCT/IB08/54691

§ 371 Date: May 7, 2010

(30) Foreign Application Priority Data
Nov. 14, 2007 (EP) 07120629.6

(51) Int. Cl. H04N 5/14

(52) U.S. Cl. 348/700; 348/E05.062

(57) ABSTRACT

A method of determining a starting point (12) of a segment (11) corresponding to a semantic unit of an audiovisual signal includes processing an audio component of the signal to detect sections (14) satisfying a criterion for low audio power, and processing the audiovisual signal to identify boundaries of sections corresponding to shots. A video component of the audiovisual signal is processed to evaluate a criterion for identifying video sections formed by at least one shot of a certain type, comprising images in which an anchorperson is likely to be represented. If at least an end point of a section (14) satisfying the criterion for low audio power lies on a certain interval between boundaries of an identified video section (13), a point coinciding with a section (14) satisfying the criterion for low audio power and located between the boundaries of the identified video section is selected as a starting point (12) of a segment (11). Upon determining that no sections satisfying the criterion for low audio power coincide with an identified video section (13), a boundary of the video section is selected as a starting point (12) of a segment (11).

### FIELD OF THE INVENTION

The invention relates to a method of determining a starting point of a segment corresponding to a semantic unit of an audiovisual signal.

The invention also relates to a system for segmenting an audiovisual signal into segments corresponding to semantic units.

The invention also relates to an audiovisual signal, partitioned into segments corresponding to semantic units and having identifiable starting points.

The invention also relates to a computer programme.

### BACKGROUND OF THE INVENTION

Wang, C. et al., “Automatic story segmentation of news video based on audio-visual features and text information”, Proc. 2^{nd} Intl. Conf on Machine Learning and Cybernetics, Xi′an 2-5 Nov. 2003, Vol. 5, pp. 3008-3011, relates to a news story automatic segmentation scheme based on audio-visual features and text information. The basic idea is to detect shot boundaries for news video first, and then topic-caption frames are identified to get segmentation cues by using a text detection algorithm. In a next step, silence clips are detected by using short-time energy and short-time average zero-crossing rate parameters. If a silence period is contained between successive topic caption starts and the union of the silence period and the set of shot boundaries is not empty, then the frame at the position half-way through the silence period is chosen as that story boundary. If successive silence periods alternate with topic caption starts, and the union of the silence periods with the set of shot boundaries is empty, it shows that a news story is inside of one anchorperson shot and there is no shot boundary around this story. The longest silence periods between the pairs of successive topic caption starts are chosen as story boundaries.

A problem of the known method is that it relies on the presence of silence periods to determine the story boundaries. Moreover, it is necessary to detect captions in order for the method to work. Many audiovisual signals representing news items include news items without a silence period or a caption.

### SUMMARY OF THE INVENTION

It is an object of the invention to provide a method, system, audiovisual signal and computer programme for detecting starting points of semantic units with characteristics similar to those of news items in an audiovisual signal relatively precisely and over a relatively large range of types of news items.

This object is achieved by the method of determining a starting point of a segment corresponding to a semantic unit of an audiovisual signal according to the invention, which includes

processing an audio component of the signal to detect sections satisfying a criterion for low audio power, and

processing the audiovisual signal to identify boundaries of sections corresponding to shots,

wherein a video component of the audiovisual signal is processed to evaluate a criterion for identifying video sections formed by at least one shot meeting a criterion for identifying a shot of a certain type comprising images in which an anchorperson is likely to be represented, which video sections include only shots of the certain type,

wherein, if at least an end point of a section satisfying the criterion for low audio power lies on a certain interval between boundaries of an identified video section, a point coinciding with a section satisfying the criterion for low audio power and located between the boundaries of the identified video section is selected as a starting point of a segment, and wherein,

upon determining that no sections satisfying the criterion for low audio power coincide with an identified video section, selecting a boundary of the video section as a starting point of a segment.

A shot is a contiguous image sequence that a real or virtual camera records during one continuous movement, which represents a continuous action in both time and space in a scene. The criterion for low audio power can be a criterion for low audio power relative to other parts of the audio component of the signal, an absolute criterion, or a combination of the two. Although the method is described herein primarily with reference to news broadcasts, other types of audiovisual signals built up of items introduced by a person acting as a compère can similarly be segmented.

By selecting a boundary of a likely anchorperson shot of at least one certain type as the starting point of the segment upon determining that no sections satisfying the criterion for low audio power coincide with the shot satisfying the criterion for identifying shots of the certain types, it is ensured that a starting point is associated with the section that meets the criteria for identifying the appropriate anchorperson shots or uninterrupted sequences of anchorperson shots. Thus, even if a news item does not start with a silence, or contain a silence, a point of an appropriate anchorperson shot will still be identified as the starting point of a news item. Because a point coinciding with the section satisfying the criterion for low audio power and located between the boundaries of the identified video section is selected as the starting point of the segments if at least an end point of a section satisfying the criterion for low audio power lies on an interval between boundaries of an identified video section, starting points are determined relatively precisely. In particular, the starting point can be determined exactly when a news reader makes an announcement bridging two successive news items. This is because there is likely to be a pause corresponding to a section of low audio power just before the news reader moves on to the next news item. The above effects are achieved independently of the type of anchorperson shots that are present in the audiovisual signals. It is sufficient to locate appropriate anchorperson shots and sections satisfying the criterion for low audio power. Thus, the method is suitable for many different types of news broadcasts.

In an embodiment, processing the video component of the audiovisual signal includes evaluating the criterion for identifying a shot of the certain type, which evaluation includes determining whether at least one image of a shot satisfies a measure of similarity to at least one further image.

An effect is that use is made of the characteristics of anchorperson shots, which is that they are relatively static throughout a news broadcast. It is not necessary to rely on the detection of any particular type of content. Thus, the method is suitable for use with a wide range of news broadcasts, regardless of the types of backgrounds, the presence of sub-titles or logos or other characteristics of anchorperson shots, including also how the anchorperson is shown (full-length, behind a desk or dais, etc.).

In a variant, evaluating the criterion for identifying a shot of the certain type includes determining whether at least one image of a shot satisfies a measure of similarity to at least one further image included in the shot.

This variant takes advantage of the fact that anchorperson shots are relatively static. The anchorperson is generally immobile, and the background does not change much.

In a variant, evaluating the criterion for identifying a shot of the certain type includes determining whether at least one image of a shot satisfies a measure of similarity to at least one further image of at least one further shot.

This variant takes advantage of the fact that different anchorperson shots in a programme from a particular source resemble each other to a large extent. In particular, the presenter is generally the same person and is generally represented in the same position, with the same background.

An embodiment of the method includes analysing a homogeneity of distribution of shots including similar images over the audiovisual signal.

Items in a broadcast tend to be of similar length, so that anchorperson shots should be distributed relatively homogeneously over the programme. Contiguous shots that resemble each other but do not reoccur will tend to be parts of the same single semantic unit rather than anchorperson shots.

In an embodiment, processing the video component of the audiovisual signal includes evaluating the criterion for identifying a shot of the certain type, which evaluation includes analysing contents of at least one image comprised in the shot to detect any human faces represented in at least one image included in the shot.

This embodiment is relatively effective at detecting anchorperson shots across a wide range of broadcasts. It is relatively indifferent to cultural differences, because in almost all broadcast cultures the face of the anchorperson is prominent in the anchorperson shots.

In an embodiment, processing the video component of the audiovisual signal to evaluate the criterion for identifying video sections includes at least one of:
a) determining whether a shot is a first of a sequence of successive shots, each determined to meet the criterion for identifying shots of the certain type comprising images in which an anchorperson is likely to be represented, with the sequence having a length greater than a certain minimum length, and
b) determining whether a shot meets the criterion for identifying shots of the certain type comprising images in which an anchorperson is likely to be represented, and additionally meets a criterion of having a length greater than a certain minimum length.

This embodiment is effective in increasing the chances of identifying the entirety of a section of the audiovisual signal corresponding to one introduction by an anchorperson. In particular, where rapid changes back to the presenter, or between two presenters, occur, these are not falsely identified as introductions to a new item, e.g. a new news item, but as the continuation of an introduction to one particular news item.

An embodiment of the method includes, upon determining that at least an end point of each of a plurality of sections satisfying the criterion for low audio power lies on a certain interval between boundaries of an identified video section, selecting as a starting point of a segment a point coinciding with a first occurring one of the plurality of sections.

An effect is that, where there is an item within an anchorperson shot or back-to-back sequence of anchorperson shots, the starting point of this item is also determined relatively reliably.

A variant further includes selecting as a starting point of a further segment a point coinciding with a second one of the plurality of sections satisfying the criterion for low audio power and subsequent to the first section, upon determining at least that a length of an interval between the first and second sections exceeds a certain threshold.

Thus, where there is an item within an anchorperson shot or uninterrupted sequence of anchorperson shots and the next item starts within the same anchorperson shot or uninterrupted sequence of anchorperson shots, segmentation of items is achieved without missing any starting points.

An embodiment of the method includes, for each of a plurality of the identified video sections, determining in succession whether at least an end point of a section satisfying the criterion for low audio power lies on a certain interval between boundaries of the identified video section.

An effect is that the audiovisual signal is segmented relatively efficiently, since the starting point of a next item is generally the end point of a previous item. Thus, processing the anchorperson shots—at least one starting point of a segment is determined to coincide with each anchorperson shot in this method—in succession is an efficient way of achieving complete segmentation into semantic units of the audiovisual signal.

In an embodiment of the method, sections satisfying the criterion for low audio power are detected by evaluating average audio power over a first window relative to average audio power over a second window, larger than the first window.

An effect is that “silence periods” are determined relative to background audio levels. Thus, for example, where an anchorperson pauses whilst a background theme is playing, or where the anchorperson shot is of an anchorperson on location, pauses in the announcement are reliably identified.

According to another aspect, the system for segmenting an audiovisual signal into segments corresponding to semantic units according to the invention is configured to process an audio component of the signal to detect sections satisfying a criterion for low audio power, and

to process the audiovisual signal to identify boundaries of sections corresponding to shots,

wherein a video component of the audiovisual signal is processed to evaluate a criterion for identifying video sections formed by at least one shot meeting a criterion for identifying shots of a certain type comprising images in which an anchorperson is likely to be represented, which video sections include only shots of the certain type, and wherein the system is arranged,

upon determining that at least an end point of a section satisfying the criterion for low audio power lies on a certain interval between boundaries of an identified video section,

to select a point coinciding with the section satisfying the criterion for low audio power and located between the boundaries of the video section as a starting point of a segment, and wherein the system is arranged to select a boundary of the video section shot as a starting point of a segment, upon determining that no sections satisfying the criterion for low audio power coincide with an identified video section.

In an embodiment, the system is configured to carry out a method according to the invention.

According to another aspect, the audiovisual signal according to the invention is partitioned into segments corresponding to semantic units and having starting points indicated by the configuration of the signal, and includes

an audio component including sections satisfying a criterion for low audio power, and

a video component comprising video sections, at least one of which satisfies a criterion for identifying video sections formed by at least one shot of a certain type comprising images in which an anchorperson is likely to be represented, and includes only shots of the certain type,

wherein at least one section satisfying the criterion for low audio power and having at least an end point located on a certain interval between boundaries of a shot satisfying the criterion for identifying shots of the certain types coincides with a starting point of a segment, and wherein

at least one starting point of a segment is coincident with a boundary of a video section satisfying the criterion and coinciding with none of the sections satisfying the criterion for low audio power.

In an embodiment, the audiovisual signal is obtainable by means of a method according to the invention.

According to another aspect of the invention, there is provided a computer programme including a set of instructions capable, when incorporated in a machine-readable medium, of causing a system having information processing capabilities to perform a method according to the invention.

### BRIEF DESCRIPTION OF THE DRAWINGS

The invention will be described in further detail with reference to the accompanying drawings, in which:

FIG. 1 is a simplified block diagram of an integrated receiver decoder with a hard disk storage facility;

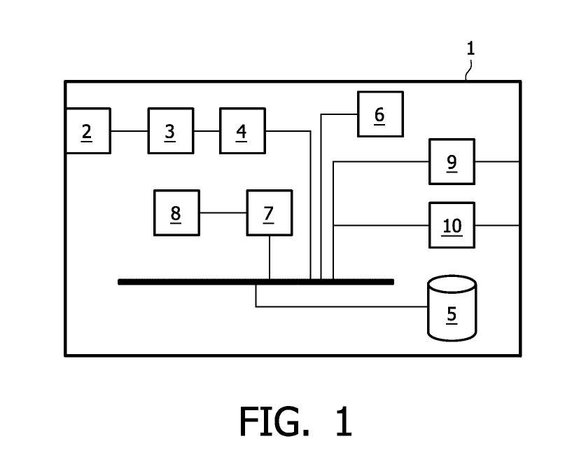

FIG. 2 is a schematic diagram illustrating sections of an audiovisual signal;

FIG. 3 is a flow chart of a method of determining starting points of news items in an audiovisual signal; and

FIG. 4 is a flow chart illustrating a detail of the method illustrated in FIG. 3.

### DETAILED DESCRIPTION OF THE EMBODIMENTS

An integrated receiver decoder (IRD) 1 includes a network interface 2, demodulator 3 and decoder 4 for receiving digital television broadcasts, video-on-demand services and the like. The network interface 2 may be to a digital, satellite, terrestrial or IP-based broadcast or narrowcast network. The output of the decoder comprises one or more programme streams comprising (compressed) digital audiovisual signals, for example in MPEG-2 or H.264 or a similar format. Signals corresponding to a programme, or event, can be stored on a mass storage device 5 e.g. a hard disk, optical disk or solid state memory device.

The audiovisual data stored on the mass storage device 5 can be accessed by a user for playback on a television system (not shown). To this end, the IRD 1 is provided with a user interface 6, e.g. a remote control and graphical menu displayed on a screen of the television system. The IRD 1 is controlled by a central processing unit (CPU) 7 executing computer programme code using main memory 8. For playback and display of menus, the IRD 1 is further provided with a video coder 9 and audio output stage 10 for generating video and audio signals appropriate to the television system. A graphics module (not shown) in the CPU 7 generates the graphical components of the Graphical User Interface (GUI) provided by the IRD 1 and television system.

Although the broadcast provider will have segmented programme streams into events and included auxiliary data for identifying such events, these events will generally correspond to complete programmes, e.g. complete news programmes, which will be used herein as an example.

More and more news programmes are being broadcast on television and the Internet. Almost every channel has its own daily news show, and many dedicated news channels have also become available. The vast amount of available content makes it nearly impossible for a user to watch all of it. Moreover, most of the news items, individual semantic units within a news programme relating to an individual topic, are usually repeated from earlier news programmes. If the user has already watched a news programme recently, he might naturally not be interested in watching the same news item again. Users are also generally not interested in watching all the available news items.

The IRD 1 is programmed to execute a routine that enables it to take a complete news programme (as identified in a programme stream, for example) and detect at which points in the programme new news items start, thereby enabling separation of the news programme into individual semantic units smaller than those identified in the auxiliary data provided with the audiovisual data representing the programme.

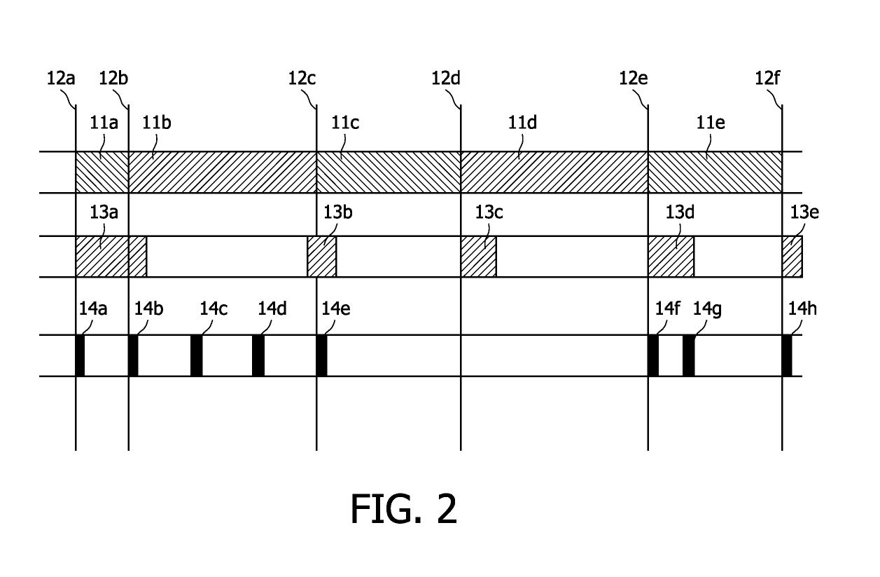

FIG. 2 is a schematic timeline showing sections of a news broadcast. Segments 11a-e of an audiovisual signal correspond to the individual news items, and are illustrated in an upper timeline representing the ground truth. Boundaries 12a-f represent the starting points of each next news item, which correspond to the end points of preceding news items.

A video component of the audiovisual signal comprises a sequence of video frames corresponding to images or half-images, e.g. MPEG-2 or H.264 video frames. Groups of contiguous frames correspond to shots. In the present context, shots are contiguous image sequences that a real or virtual camera records during one continuous movement, and which each represent a continuous action in both time and space in a scene. Amongst the shots, some represent one or more news readers, and are represented as anchorperson shots 13a-e in FIG. 2. The anchorperson shots are detected and used to determine the starting points 12 of the segments 11, as will be explained below.

An audio component of the audiovisual signal includes sections in which the audio signal has relatively low strength, referred to as silence periods 14a-h herein. These are also used by the IRD 1 to determine the starting points 12 of the segments 11 of the audiovisual signal corresponding to news items.

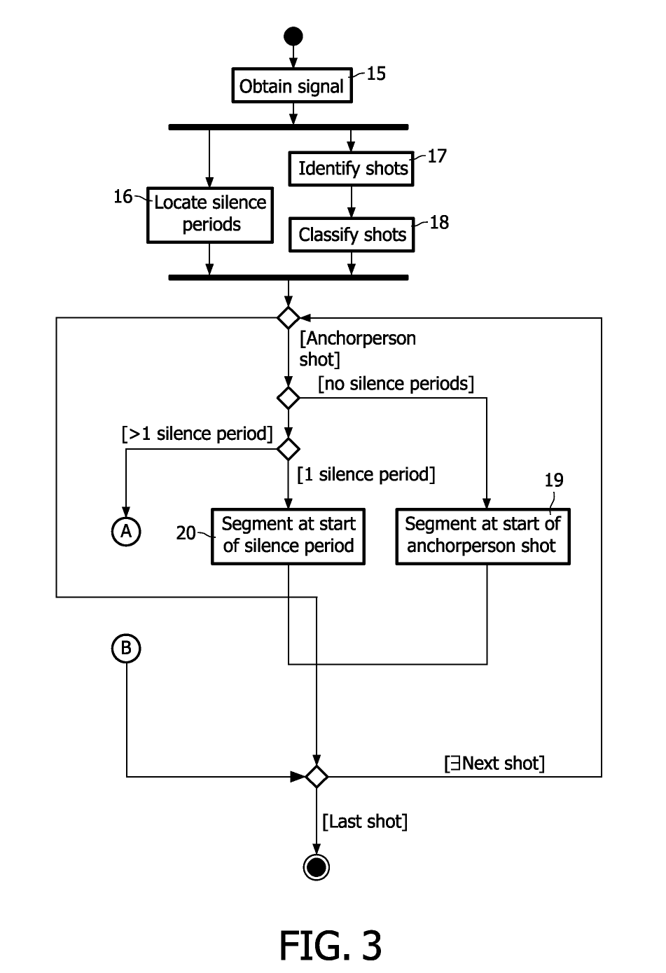

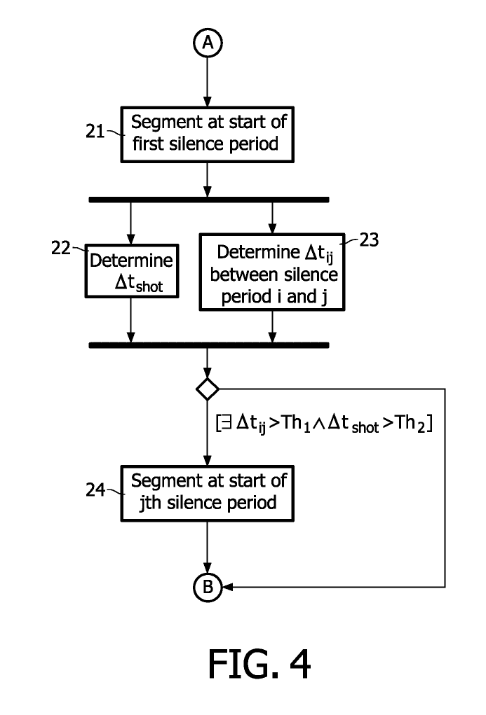

With reference to FIGS. 3 and 4, when prompted to segment an audiovisual signal corresponding to a news programme, the IRD 1 obtains the data corresponding to the audiovisual signal (step 15). It then proceeds both to locate the silence periods 14 (step 16) and to identify shot boundaries (step 17). There are, of course, many more shots than there are news items, since a news item is generally comprised of a number of shots. The shots are classified (step 18) into anchorperson shots and other shots.

In one embodiment, the step 16 of locating silence periods involves comparing the audio signal strength over a short time window with a threshold corresponding to an absolute value, e.g. a pre-determined value. In another embodiment, the ratio of the average audio power over a first moving window to the average audio power over a second window progressing at the same rate as the first window is determined. The second window is larger than the first window, i.e. it corresponds to a larger section of the audio component of the audiovisual signal. In effect, a walking average for a long period, corresponding to twenty seconds at normal rendering speed for instance, is compared to a walking average for a short period, e.g. one second. When the ratio of long to short-term average is larger than a threshold value, for instance ten, over an interval longer than a second threshold value, it is assumed that a silence period 14 has been detected. The second threshold value is high enough to ensure that only significant pauses are classed as silence periods, and is part of the criterion for low audio power. In an embodiment, only the audio power within a certain frequency range, e.g. 1-5 kHz, is determined.

The step 17 of identifying shots may involve identifying abrupt transitions in the video component of the video signal or an analysis of the order of occurrence of certain types of video frames defined by the video coding standard, for example. This step 17 can also be combined with the subsequent step 18, so that only the anchorperson shots are detected. In such a combined embodiment, adjacent anchorperson shots can be merged into one.

The step 18 of classifying shots involves the evaluation of a criterion for identifying shots comprising video frames in which one or more anchorpersons are likely to be present. The criterion may be a criterion comprising several sub-criteria. One or more of the following evaluations are carried out in this step 18.

First, the IRD 1 can determine whether at least one image of the shot under consideration satisfies a measure of similarity to at least one further image comprised in the same shot, more particularly a set of images distributed homogeneously over the shot. This serves to identify relatively static shots. Relatively static shots generally correspond to anchorperson shots, because the anchorperson or persons do not move a great deal whilst making their announcements, nor does the background against which their image is captured change much.

Second, the IRD 1 can determine whether at least one image of the shot under consideration satisfies a measure of similarity to at least one image of each of a number of further shots in the news programme, for example all the following shots. If the shot is similar to each of a plurality of further shots and these similar further shots are distributed such that their distribution surpasses a threshold value of a measure of homogeneity of the distribution, then the shot (and these further shots) are determined to correspond to anchorperson shots 13.

The similarity of shots can be determined, for example by analysing an average of colour histograms of selected images comprised in the shot. Alternatively, the similarity can be determined by analysing the temporal development of certain spatial frequency components of a selected one or more images of each shot, and then comparing these developments to determine similar shots. One can also use shot features like the amount of pixel change during the shot or the amount of movement that is present in the shot to determine how similar the images comprised in the shot are to each other. Other measures of similarity are possible, and they can be applied alone or in combination to determine how similar the shot under consideration is to other shot, or how similar the images comprised in the shot are to each other.

A measure of homogeneity of distribution could be the standard deviation in the time interval between similar shots, or the standard deviation relative to the average length of that time interval. Other measures are possible.

Third, alternatively or additionally to an assessment of similarity, the contents of individual images comprised in the shot under consideration can be analysed to determine whether it is an anchorperson shot. In particular, foreground/background segmentation can be carried out to analyse images for the presence of certain types of elements typical for an anchorperson shot. For example, a face detection and recognition algorithm can be carried out. The detected faces can be compared to a database of known anchorpersons stored in the mass storage device 5. In another embodiment, faces are extracted from a plurality of shots in the news programme. A clustering algorithm is used to identify those faces recurring throughout the news programme. Those shots comprising more than a pre-determined number of one or more images in which the recurring face is represented, are determined to correspond to anchorperson shots 13.

All the above variants of this step 18 can be carried out on frames, or half-images, instead of images.

It is observed that the criterion for identifying anchorperson shots may be limited to only anchorperson shots of a certain type or certain types. In particular, the criterion may involve rejecting shots that are very short, e.g. shorter than ninety seconds. Other types of filter may be applied.

After the anchorperson shots 13 have been identified and the silence periods 14 located, a heuristic logic is used to determine the starting points 12 of the segments 11 corresponding to news items. Shots, and in particular the anchorperson shots 13 are processed in succession, because the starting point 12 of one segment 11 is the end point of the preceding segment 11, so that successive processing of at least the anchorperson shots 13 is most efficient.

At least one starting point 12 is associated with each anchorperson shot 13, regardless of whether any silence periods 14 occur during that anchorperson shot 13. Indeed, if it is determined that no sections of the audio component corresponding to silence periods 14 have at least an end point located on an interval within the boundaries of the anchorperson shot 13, a starting point of that anchorperson shot 13 is identified as the starting point 12 of a segment 11 (step 19). Thus, if no silence is detected during the anchorperson shot 13, for example because a silence period occurs just before the anchorperson shot 13, then the news item is segmented at the start of the anchorperson shot 13. For example, a third anchorperson shot 13c in FIG. 2 overlaps with none of the silence periods 14, and therefore its starting point is identified as the starting point 12d of the fourth segment 11d.

If only one silence period 14 has at least an end point located on an interval within the boundaries of an anchorperson shot 13, then a point coinciding with the silence period 14 is selected (step 20) as the starting point 12 of a segment 11. This point may be the starting point of the silence period 14 or a point somewhere, e.g. halfway through, on the interval corresponding to the silence period 14. Silence periods 14 extending into the next shot are not considered in the illustrated embodiment. Indeed, the interval between boundaries of an anchorperson shot 13 on which at least the end point of the silence period 14 must lie, generally ends some way short of the end boundary of the anchorperson shot 13, e.g. between five and nine seconds or at 75% of the shot length. In the illustrated embodiment, however, the interval corresponds to the entire anchorperson shot 13. Using the illustrated heuristic, a fifth silence period 14e coinciding with a second anchorperson shot 13b in FIG. 2 is identified as the starting point 12c of a third segment 11c.

If it is determined that a plurality of silence periods 14 have at least an end point located on an interval between the boundaries of the anchorperson shot 13 under consideration (FIG. 4), then a point coinciding with a first occurring one of the silence periods is selected as the starting point of a segment (step 21). Thus, in FIG. 2, a first silence period 14a and second silence period 14b both coincide with a first anchorperson shot 13a. The first silence period 14a is selected as the starting point 12a of a first segment 11a. Similarly, a sixth silence period 14f and a seventh silence period 14g have at least an end point on an interval within the boundaries of a fourth anchorperson shot 13d. A point coinciding with the sixth silence period 14f is selected as a starting point 12e of a fifth segment 11e.

It may be the case that a news item is completely contained within the boundaries of a single anchorperson shot 13. The anchorperson will generally pause between news items, or a handover between two anchorpersons may occur at that point. In either case there would be a short silence. The IRD 1 determines a total length Δtₛₕₒₜ of the anchorperson shot 13 under consideration (step 22). The IRD 1 also determines the length of each interval Δt₁ⱼ between the first and next ones of the silence periods occurring during the anchorperson shot 13 (step 23). If the length of any of these intervals Δt₁ⱼ exceeds a certain threshold, then the silence period at the end of the first interval to exceed the threshold is the start 12 of a further segment 11. The threshold may be a fraction of the total length Δtₛₕₒₜ of the anchorperson shot 13. In the illustrated embodiment, a further starting point is only selected (step 24) if the length of any of the intervals Δt₁ⱼ between silence periods exceeds a first threshold Th₁ and the total length Δtₛₕₒₜ of the anchorperson shot 13 exceeds a second threshold Th₂. These steps 23,24 can be repeated by calculating interval lengths from the silence period 14 coinciding with the second starting point, so as to find a third starting point within the anchorperson shot 13 under consideration, etc. Referring to FIG. 2, a first silence period 14a and second silence period 14b both coincide with a first anchorperson shot 13a. The second silence period 14b is selected as the starting point 12b of a second segment 11b, because the first anchorperson shot 13a is sufficiently long and the interval between the first silence period 14a and the second silence period 14b is also sufficiently long. By contrast the interval between the sixth silence period 14f and the seventh silence period 14g is too short and/or the fourth anchorperson shot 13d is too short.

It will be evident from FIG. 2 that a third and fourth silence period 14c,d, which haven't at least an end point coincident with a point on an interval between the boundaries of an anchorperson shot 13, are not selected as starting points 12 of segments 11 corresponding to news items.

Through a determination of the locations of starting points 12 of the segments 11 corresponding to news items, the audiovisual signal can be indexed to allow fast access to a particular news item, e.g. by storing data representative of the starting points 12 in association with a file comprising the audiovisual data. Alternatively, that file may be segmented into individual files for separate processing. In either case, the IRD 1 is able to provide the user with more personalised news content, or at least to allow the user to navigate inside news programmes segmented in this way. For example, the IRD 1 is able to present the user with an easy way to skip over those news items that the user is not interested in. Alternatively, the device could present the user with a quick overview of all items present in the news programme, and allow the user to select those he or she is interested in.

It should be noted that the embodiments described above illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

Although an implementation using an IRD 1 has been described, the methods outlined herein could easily be implemented on a personal or handheld computer, digital television set or similar device.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. ‘Computer programme’ is to be understood to mean any software product stored on a computer-readable medium, such as an optical disk, downloadable via a network, such as the Internet, or marketable in any other manner.

1. Method of determining a starting point (12) of a segment (11) corresponding to a semantic unit of an audiovisual signal, including
processing an audio component of the signal to detect sections (14) satisfying a criterion for low audio power, and
processing the audiovisual signal to identify boundaries of sections corresponding to shots,
wherein a video component of the audiovisual signal is processed to evaluate a criterion for identifying video sections formed by at least one shot meeting a criterion for identifying a shot of a certain type comprising images in which an anchorperson is likely to be represented, which video sections include only shots of the certain type,
wherein, if at least an end point of a section (14) satisfying the criterion for low audio power lies on a certain interval between boundaries of an identified video section (13), a point coinciding with a section (14) satisfying the criterion for low audio power and located between the boundaries of the identified video section (13) is selected as a starting point (12) of a segment (11), and wherein,
upon determining that no sections satisfying the criterion for low audio power coincide with an identified video section (13c), a boundary of the video section is selected as a starting point (12d) of a segment (11d).

2. Method according to claim 1, wherein processing the video component of the audiovisual signal includes evaluating the criterion for identifying a shot of the certain type, which evaluation includes determining whether at least one image of a shot satisfies a measure of similarity to at least one further image.

3. Method according to claim 2, wherein evaluating the criterion for identifying a shot of the certain type includes determining whether at least one image of a shot satisfies a measure of similarity to at least one further image included in the shot.

4. Method according to claim 2, wherein evaluating the criterion for identifying a shot of the certain type includes determining whether at least one image of a shot satisfies a measure of similarity to at least one further image of at least one further shot.

5. Method according to claim 4, including analysing a homogeneity of distribution of shots including similar images over the audiovisual signal.

6. Method according to claim 1, wherein processing the video component of the audiovisual signal includes evaluating the criterion for identifying a shot of the certain type, which evaluation includes analysing contents of at least one image comprised in the shot to detect any human faces represented in at least one image included in the shot.

7. Method according to claim 1, wherein processing the video component of the audiovisual signal to evaluate the criterion for identifying video sections includes at least one of:
a) determining whether a shot is a first of a sequence of successive shots, each determined to meet the criterion for identifying shots of the certain type comprising images in which an anchorperson is likely to be represented, with the sequence having a length greater than a certain minimum length and
b) determining whether a shot meets the criterion for identifying shots of the certain type comprising images in which an anchorperson is likely to be represented, and additionally meets a criterion of having a length greater than a certain minimum length.

8. Method according to claim 1, including, upon determining that at least an end point of each of a plurality of sections (14a,b,f,g) satisfying the criterion for low audio power lies on the certain interval between boundaries of an identified video section (13a,d), selecting as a starting point (12a,e) of a segment (11a,e) a point coinciding with a first occurring one of the plurality of sections (14a,b,f,g).

9. Method according to claim 8, further including selecting as a starting point of a further segment (11b) a point coinciding with a second one of the plurality of sections (14a,b) satisfying the criterion for low audio power and subsequent to the first section (14a), upon determining at least that a length of an interval (Dtᵢⱼ) between the first and second sections (14a,b) exceeds a certain threshold.

10. Method according to claim 1, including, for each of a plurality of the identified video sections (13), determining in succession whether at least an end point of a section (14) satisfying the criterion for low audio power lies on the certain interval between boundaries of the identified video section (13).

11. Method according to claim 1, wherein sections (14) satisfying the criterion for low audio power are detected by evaluating average audio power over a first window relative to average audio power over a second window, larger than the first window.

12. System for segmenting an audiovisual signal into segments (11) corresponding to semantic units, which system is configured to
process an audio component of the signal to detect sections (14) satisfying a criterion for low audio power, and
to process the audiovisual signal to identify boundaries of sections corresponding to shots,
wherein a video component of the audiovisual signal is processed to evaluate a criterion for identifying video sections (13) formed by at least one shot meeting a criterion for identifying shots of a certain type comprising images in which an anchorperson is likely to be represented, which video sections include only shots of the certain type, and wherein the system is arranged,
upon determining that at least an end point of a section (14) satisfying the criterion for low audio power lies on a certain interval between boundaries of an identified video section (13),
to select a point coinciding with the section (14) satisfying the criterion for low audio power and located between the boundaries of the video section (13) as a starting point (12) of a segment (11), and wherein
the system is arranged to select a boundary of the video section (13) as a starting point (12) of a segment (11), upon determining that no sections (14) satisfying the criterion for low audio power coincide with an identified video section (13).

13. System for segmenting an audiovisual signal into segments (11) corresponding to semantic units, which system is configured to
process an audio component of the signal to detect sections (14) satisfying a criterion for low audio power, and
to process the audiovisual signal to identify boundaries of sections corresponding to shots,
wherein a video component of the audiovisual signal is processed to evaluate a criterion for identifying video sections (13) formed by at least one shot meeting a criterion for identifying shots of a certain type comprising images in which an anchorperson is likely to be represented, which video sections include only shots of the certain type, and wherein the system is arranged,
upon determining that at least an end point of a section (14) satisfying the criterion for low audio power lies on a certain interval between boundaries of an identified video section (13),
to select a point coinciding with the section (14) satisfying the criterion for low audio power and located between the boundaries of the video section (13) as a starting point (12) of a segment (11), and wherein
the system is arranged to select a boundary of the video section (13) as a starting point (12) of a segment (11), upon determining that no sections (14) satisfying the criterion for low audio power coincide with an identified video section (13), configured to carry out a method according to claim 1.

14. Audiovisual signal, partitioned into segments (11) corresponding to semantic units and having starting points (12) indicated by a configuration of the signal, including
an audio component including sections (14) satisfying a criterion for low audio power, and
a video component comprising video sections, at least one of which satisfies a criterion for identifying video sections formed by at least one shot of a certain type comprising images in which an anchorperson is likely to be represented, and includes only shots of the certain type,
wherein at least one section (14) satisfying the criterion for low audio power and having at least an end point located on a certain interval between boundaries of a video section (13) satisfying the criterion coincides with a starting point (12) of a segment (11), and wherein
at least one starting point (12d) of a segment (11d) is coincident with a boundary of a video section (13c) satisfying the criterion and coinciding with none of the sections (14) satisfying the criterion for low audio power.

15. Audiovisual signal, partitioned into segments (11) corresponding to semantic units and having starting points (12) indicated by a configuration of the signal, including
an audio component including sections (14) satisfying a criterion for low audio power, and
a video component comprising video sections, at least one of which satisfies a criterion for identifying video sections formed by at least one shot of a certain type comprising images in which an anchorperson is likely to be represented, and includes only shots of the certain type,
wherein at least one section (14) satisfying the criterion for low audio power and having at least an end point located on a certain interval between boundaries of a video section (13) satisfying the criterion coincides with a starting point (12) of a segment (11), and wherein
at least one starting point (12d) of a segment (11d) is coincident with a boundary of a video section (13c) satisfying the criterion and coinciding with none of the sections (14) satisfying the criterion for low audio power, obtainable by means of a method according to claim 1.

16. Computer programme including a set of instructions capable, when incorporated in a machine-readable medium, of causing a system having information processing capabilities to perform a method according to claim 1.
